(19) United States
(12) Patent Application Publication
(10) Pub. No.: US 2006/0005172 A1
(43) Pub. Date: Jan. 5, 2006

(54) Method of computer code conversion and computer product/program for the implementation of such a method

(75) Inventor: Emmanuel Fuchs, Chatillon (FR)

Correspondence Address: LOWE HAUPTMAN GILMAN & BERNER, LLP, 1700 DIAGNOSTIC ROAD, SUITE 300, ALEXANDRIA, VA, 22314, US

(73) Assignee: THALES, Neuilly Sur Seine (FR)

(21) Appl. No.: 11/168,434

(22) Filed: Jun. 29, 2005

(30) Foreign Application Priority Data
Jul. 2, 2004 (FR) 04 07381

(51) Int. Cl. G06F 9/45

(52) U.S. Cl. 717/136

(57) ABSTRACT

The method comprises at least: a first step (11) for the acquisition of a code object model A from the original code (1); a second step (12) of conversion of the code object model A into a new object model B; a third step (13) of the generation of a code from the new model B. The invention applies especially to the automatic conversion of existing validated code, either from one language to another or within the same language through a modification of the original code, for example in order to correct its errors.

### BACKGROUND OF THE INVENTION

1. Field of the Invention

The present invention relates to a method for the conversion of computer code. The invention applies especially to the automatic conversion of existing validated code, either from one language to another or within the same language through a modification of the original code, for example in order to correct its errors. The invention also relates to a computer program/product for the implementation of the method.

2. Description of the Prior Art

A colossal amount of code lines has been produced since the appearance of data processing. Without going very back in time, and remaining for example within the context of the last 15 years, a large quantity of lines has been written in obsolete language, or at least in language for which the competence is almost lost. Furthermore, successive patches have been added to most of these programs in disordered fashion so that the original software architecture has thereby been totally altered. Now, these programs are still used in existing equipment or systems which moreover have to make progress. It is therefore necessary for software programs to get upgraded. However, once a software upgrading is proposed, problems of functional upgrading appear as the person or persons responsible for the modifications do not master the software.

For example, we may consider a radar system. The functions are constantly making progress. However, the existing equipment and functions, hence especially the previously produced code lines, have to be kept. In particular, it is impossible to rewrite the programs that command or control the sub- units. The existing code therefore raises at least two problems, first of all in maintenance and secondly with respect to upgrading. As regards maintenance, since the system as a whole is always active, it is necessary to have the capacity, if necessary, to take action on this existing code, for example to correct its errors. However, knowledge or mastery of the language gets lost, thus seriously complicating any action. As regards progress, interfacing with new programs necessitates a minimum mastery of the existing code. This considerably burdens the implementation of the modifications because it is often necessary to make modifications in the existing code, which is poorly known, in order to interface it with a new program.

More generally in practice, what is done therefore is to re-utilize the software, which is available in the form of source code. Indeed, there are cases of re- utilization where, for essentially economic reasons, it is not possible to discard the existing software and start from scratch. Paradoxically, the greater the initial investment, the less is it possible to backtrack. But the greater the investment, the further the situation deteriorates because the foundations are not sound. It is necessary to be able to backtrack automatically in order to redesign systems in the light of experience. What has to be done therefore is to convert the code of an existing application in order to change some of its structural elements. Indeed, the code of an existing, operational application, while functionally valid, may need to have its form revised for use in a new context.

The numerous cases entailing a conversion of existing code include for example:
changes in programming rules;
company acquisitions and mergers;
purchases and the sales of software technologies;
technological change or obsolescence.

Changes in programming rules imply either the application of new programming rules or the initial setting up of programming rules whereas the code already exists. This is the case especially when the quality constraints of the code are reinforced for reasons of operating safety. Breaking programming rules does not prevent the program from functioning but may engender side effects following a subsequent modification or change of the external parameters. This case of application will be based, for example, on the programming rules relating to a particular field. For example, for reasons of operating safety, certain operations of dynamic creation of instances are henceforth ruled out. It is therefore necessary to search for and convert dynamic behavior into static behavior.

In company mergers or acquisitions, it is necessary to set up convergence between information systems. What has to be done in this case is to retrieve the information system configuration systems to modify them without infringing the accounting and fiscal regulations. This is the case for example for the ERP (a company management software package) configuration. It must be verified that the configuration complies with the fiscal and accounting regulations. If this is not the case, the configuration must be redone without jeopardizing the value of the existing information. The main difficulty here is to do the upgrading while the system is functioning. Indeed, the entire operational functioning of the company depends on the availability of the information system. There may also be a case where the software package changes and it is sought to retrieve the configuration of the former package to configure the new one identically. It is therefore necessary to define the conversion rules as a function of both these professional software programs. In the case of technology transfer, the source code of the programs does not constitute real capital, and it must be possible to appropriate the basic principles of the designing of the technology. This appropriation phase begins with a process of upgrading the sources to match the program to the development process of the company.

In the event of technological change or obsolescence, the existing application uses the services of another application. The application code makes explicit reference to calls from this external application. In the event of obsolescence or replacement of the external application by another application, calls on the services of the former application must be replaced by calls on the services of the new application.

Prior art “retro-engineering” tools dictate manual operations to modify the existing codes or offer a restricted number of automatic corrections.

### SUMMARY OF THE INVENTION

It is an aim of the invention especially to make it possible to avoid complicated action by hand, which leads to costs and additional problems. To this end, an object of the invention is a method for the conversion of computer code, comprising at least:
a first step for the acquisition of a code object model A from the original code;
a second step of conversion of the code object model A into a new object model B;
a third step of the generation of a code from the new model B

The step of acquisition of the code model A comprises:
a first step of creation of a syntactic tree as a function of the grammar of the original code;
a second step of conversion of the syntactic tree into a code model A.

The conversion of the syntactic tree into an object model A uses conversion rules to represent each node of the tree as an object.

The creation of the object model A is based on a meta-model forming a grammar describing the structural elements of the modeling language.

The step of conversion of the code model A comprises:
a step of searching for patterns in the code model A;
an acquisition step to extract the elements of a zone of the model A corresponding to a pattern identical to or different from a pattern being sought;
a conversion step in which the extracted elements are modified as a function of a rule.

The search step applies a pattern template to retrieve a pattern in the code model A, the chosen pattern being filtered by the template.

The search criteria relate to the structure of the program blocks to which a structure of the syntactic tree corresponds, the definition of the patterns being based on the description of the specific structures of the tree.

The invention also relates to a computer product/program for the implementation of the method according to the invention.

The main advantages of the invention are that it finds numerous applications and is simple to implement and economical.

### BRIEF DESCRIPTION OF THE DRAWINGS

Other features and advantages of the invention shall appear from the following description, made with reference to be appended drawings, of which:

FIG. 1 illustrates the main steps of the method according to the invention;

FIG. 2 presents the steps in greater detail;

FIG. 3 illustrates the search step in the phase of conversion of a code model;

FIG. 4 exemplifies a conversion of the tree of the model;

FIG. 5 presents modules forming the computer product/program for the implementation of the method according to the invention.

### MORE DETAILED DESCRIPTION

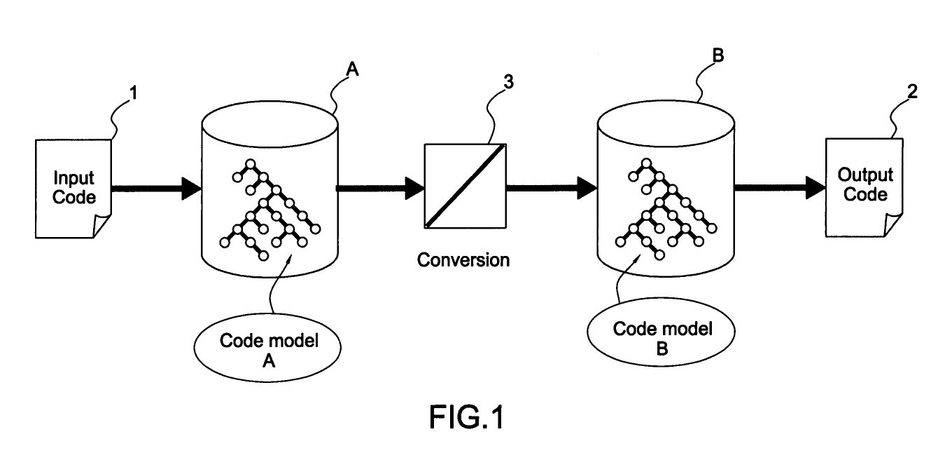

FIG. 1 illustrates the main steps of a method according to the invention, a typical use of which concerns for example the correction of faults of implementation of the programming languages. The method of the invention enables the automatic conversion of an existing code, the input code 1, either into another language or within a same language through the modification of the original code, for example in order to correct its faults. A new code 2 is obtained as a result of the implementation of the method. This conversion is based on the conversion of the object model of the existing code, which shall hereinafter be called the code model A. The code model is made automatically, for example by a compiler. A user defines the rules of conversion of the model A from the existing code 1 into a new code object model B from which the new code 2 is generated. In fact the model A of the existing code is, for example, defective and therefore must be converted into a new model B. The model A is defective because of errors in the existing code 1, either through the obsolescence of the existing code, or again through mismatching with a new piece of hardware for example. The user therefore defines a conversion program 3 to modify the code model A into a code model B. The new model B then forms a new database from which it will be possible to reprogram the code to obtain the output code 2.

FIG. 1 therefore illustrates three steps of the method according to the invention, namely the acquisition of the code model A, the automatic conversion of the code model A into a corrected code model B and automatic code generation 2 from this new code model B. A preliminary step is the writing of the conversion rules.

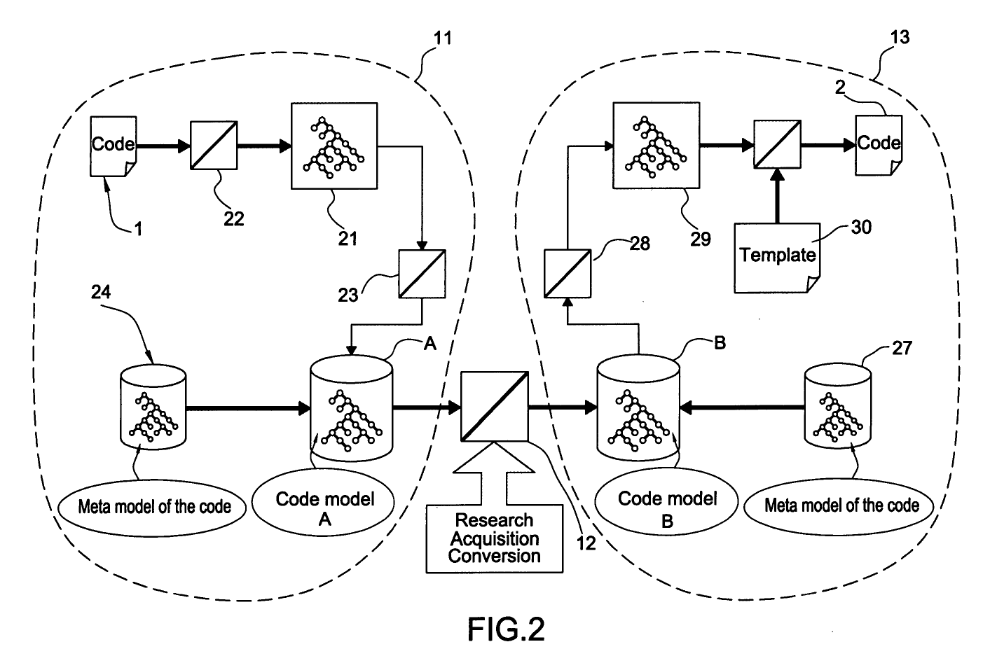

FIG. 2 gives a more precise illustration of these steps of the method according to the invention, a step 11 of acquisition of the code model, a step 11 of conversion of the code model and a step 13 of generation of the output code.

The acquisition of the code model A is therefore made in a first step 11. According to the invention, the acquisition of the code model is a rising-order acquisition. Indeed, a model is situated at a level of abstraction higher than that of its instance. Now, in this step 11, the model A is built in relation to its instance: namely the code. The usual modeling approaches are the descending-order approaches because, first of all, a model is made to generate the skeleton of the program. The programmer must then fill in the procedure bodies manually.

The acquisition step 11 comprises a first step for the creation of a syntactic tree 21. Inside this acquisition step 11, a first phase therefore consists in analyzing the input code 1. The result of the analysis is stored in the syntactic tree 21. This is a known code compilation step. The syntactic tree 21 is built as a function of the grammar of the language, also called BNF (or “Backus-Naur Form”). In particular, the input code is processed by a front end 22. This front end 22 communicates with the specifications file of the input code 1. It also communicates with a file describing the grammar of the input code. The front end 22 therefore deals with two series of input data, the series given by the specifications file, describing especially the syntax of the language, and the series given by the grammar file. The grammatical analysis performed classically by the end file 22 enables the front end to extract the highest-level data contained in the specifications file and therefore obtain the syntactic tree 21.

A second step within the acquisition step 11 consists in converting the syntactic tree 21 into an object model of the code 1. In particular, instead of performing the rest of the processing operations on the basis of the syntactic tree 21, as is the case for example for a compiler, the syntactic tree 21 of the invention is converted into an object model of the code. The principle of the conversion of the syntactic tree 21 into an object model consists especially in defining conversion rules to represent each node of the tree 21 as an object. The conversion of the syntactic tree 21 into code model A is done by a functional unit 23, which is a model generator. The principle of object modeling lies especially in defining a set of classes to represent the concepts to be modeled. Object programming actually defines a set of formal principles to describe the structure of the model. In the case of the invention, each node of the tree is an instance of a class. The type of class depends on the type of content of the node. Each construction of the language has a class corresponding to it. The legacy tree of the classes of the object model of the syntactic tree 21 is built as a function of the grammar of the language describing the above-mentioned BNF. The classes are interlinked by a legacy graph according to their common characteristics. The legacy tree may, for example, comprise one branch for control and execution operations, one branch for the sub-program management and one branch for the operators. The object approach advantageously enables the use of an object language to navigate in the tree. It also enables the use of introspection techniques to search for complex structures in the tree. Furthermore, unlike an object model derived from the manual descending-order modeling, this code model A is complete. Indeed, it represents a program that functions in reality whereas the application models derived from a classic descending-order approach are not complete. Indeed, in the descending-order approach it is impossible to model all the details of the application. The descending-order approach necessitates the manual edition of a code to correspond to a complete application.

The principle of object modeling is based on the definition of the grammar 24 for the modeling language. The grammar describes the structural elements of the modeling language. It is the description model of the code model A. This grammar will hereinafter be called a meta-model. A meta-model provides information on the model in general just as, for example, by analogy, a legend provides information on roadmaps. The meta-model defines especially the basic concepts used to describe the model. In the case of the code model A, it is the grammar of the language, namely the BNF language. In particular, the meta-model may be obtained by compilation of the BNF of the language. In other words, according to the invention, the description language of the BNF is compiled to generate its meta-model. Usually, in the descending-order modeling approach, the model describes complex environments for which the meta-model must be written manually because the concepts handled are very specific. In the invention, the meta-model 24 of the code defines the way in which to represent a computer language in the form of model. This advantageously corresponds to very simple concepts in the case of a compiler.

Initially, therefore, a meta-model is obtained that is dedicated to the programming language of the application, i.e. the input code 1. A subsequent step may lie in the use of a generic code meta-model to represent all the programming languages in the same way. It is possible to broaden the meta-modeling approach to define a meta-model that can be applied to all the programming languages. This makes it possible especially to generate code from the definition of a model independent of the programming languages, hence to generate code in language other than the input language, for instance to convert Ada language into C language.

In a second phase 12, the initial model, i.e. the model A obtained from the input code 1, is converted. Following the conversion, a second model is obtained by copying with modification of the initial model. This second model is called the model B. The phase of conversion of the initial model A can be subdivided into several steps 25:
a search step;
an acquisition step;
a conversion step.

The steps constitute a conversion scenario. A complex conversion may be the object of the execution of several scenarios.

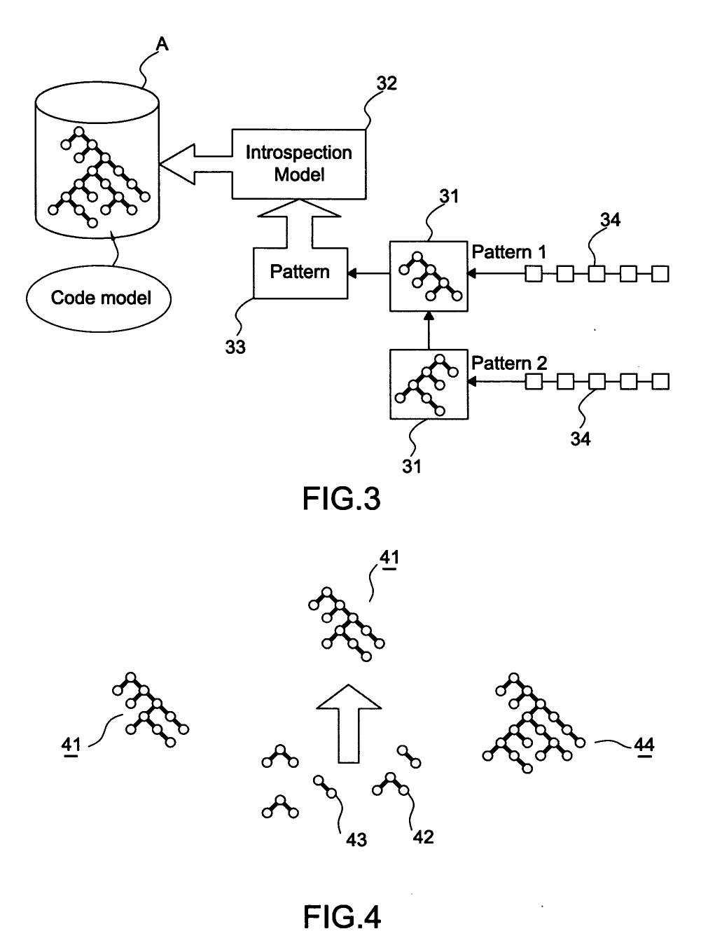

FIG. 3 illustrates the search step, more particularly the introspection of the code model A. In particular, this step searches for the procedures which are parameters that are not characterized. They thus search for bugs or patterns.

The search phase consists, for example, in applying a pattern template 31 to retrieve a pattern in the code model A. The user has, for example, a pattern description language 32, forming an introspection model of the code model. The pattern search language is based, for example, on the generic meta-model of the above-mentioned code. It possesses its own meta-model. Each field of application may have its own search criteria. Libraries of reusable patterns can be built rapidly. Each pattern description may contain one or more templates 31 used to filter elements of the pattern being sought. The patterns chosen are thus filtered by the template or templates. The template may also contain predicates 34 used to refine the filtering conditions of the template. It is also possible to build patterns from existing patterns, comprising existing templates. It is also possible to define a complex combination of the template in the form of equations. Once again, the templates and their algebra are defined in a meta-model.

In the acquisition step, each positive search has a corresponding reading of the model to extract the elements of a zone of the model A corresponding to an identical pattern or a pattern different from the search pattern 33. A filtering on the extraction is also defined. It is also possible to save the result of the extraction in a temporary buffer and subsequently use it in another conversion scenario.

During the conversion step, the elements extracted from the model A are then modified according to a conversion rule. The conversion is also described with a conversion language. This language is a statement language. The defines the actions to be performed as a function of the type of elements extracted from the model. The conversion language is a full-fledged language and, to enable simple and efficient implementation, it is based on a specific meta-model. Simple examples of conversion are, for example:
the growth of the syntactic tree of the model;
the declaration of the tree;
substitution.

FIG. 4 illustrates an example of conversion that is a growth of the tree. The conversion consists especially of the addition of the elements 42, 43 to the tree 41 of the initial model, or to a part of the tree of the initial model, to define a final tree 44. In the example of FIG. 4, this is a tree structure to which nodes are added. A node can also be replaced by a group of nodes.

With regard to the pattern search language 32, the search criteria relate to the structure of the blocks of the program to which a structure of the syntactic tree corresponds. The principle of definition of the patterns is based on the description of the specific structures of the tree. The organization of the nodes of the tree, depending on their type, makes it possible to determine a configuration of the typical code. This technique is close to the one used in the compilers to optimize the generation of the assembler code. According to the invention, it is applied to the high-level code, i.e. at the level of the model. Classic techniques are thus used in a novel fashion, especially through the use of the object modeling approach. The pattern search language may also use techniques of semantic analysis based on the algorithmics of trees. For example, for the scanning of the branches, the shortest path search, the loop search or the maximum search may be used.

The conversion language used enables a description of the elements of the model to be converted. Any entity of the meta-model of the language may form the object of a conversion. The conversions are described relative to the meta-model and they are then applied to the model of the code. It is possible to define endogenous conversions which convert elements of a meta-model into elements of the same meta-model and exogenous conversions which convert the elements of the initial meta-model into elements of the end meta-model. Referring to FIG. 2, in the case of an endogenous conversion, the meta-model 27 associated with the code model B is the same meta-model as the one associated with the initial model A. In case of an exogenous conversion, the meta-model 27 associated with the code model B is the new end meta-model. The meta-model 27 associated with the code model B describes the structural elements of its modeling language.

In a third phase 13, the new output code 2 is generated. This phase uses, for example, the principle of template-based code generation to regenerate the code 2 of the application as described especially in the French patent application number 00 09971. Thus, a tree generator is constituted from the code model B. This tree generator 28 regenerates a syntactic tree 29. An encoding unit 20 delivers the output code 2. This encoding unit 20 necessitates two series of data, the data given by the syntactic tree 29 and the data given by a template file 30. This file describes especially how to use the data contained in the syntactic tree 29 and how to generate the right code.

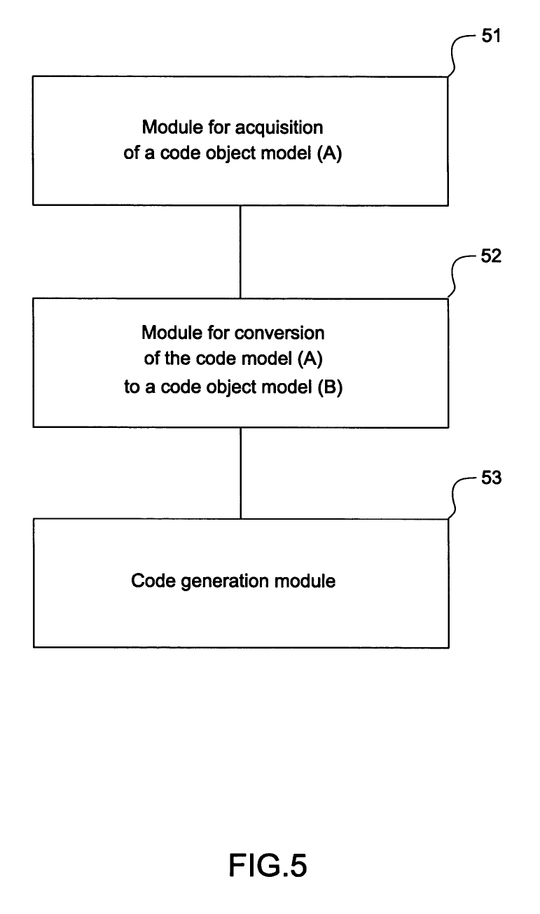

The invention also relates to a computer program/product or package for the implementation of the method described here above. FIG. 5 illustrates three main modules of such a program. The program has a first module 51 for the acquisition of a code object model A corresponding to the original code. This module resumes the implementation of the first step 11 described here above. The first module 51 is interfaced with a second module 52 for conversion of the code model A into a new code model B. This second module implements the following step 12 of the method according to the invention. Finally, this second module 52 is interfaced with a third module 53 for code generation from the new model B, implementing the corresponding step 13 of the method according to the invention. The module 53 is for example the one described in the French patent application number 00 09971.

The invention may be used in many applications, especially for the correction of faults. One case of use consists of the automatic modification of the code to correct cases of use of languages prohibited by the programming rules. The definition of search patterns on the basis, for example, of programming rules ensures compliance with these rules. Certain cases of code patches will necessitates several cycles, each cycle using different sets of rules. If the quality of the code to be corrected is too poor, it is possible to apply several conversion cycles with different rules, the exit from one cycle becoming the entry into the following cycle.

The correction may be used for the processing of comprehensive variables. A comprehensive variable is represented by an element directly linked to the root of the model. The search condition is therefore that of searching in all the terminal nodes affiliated to the root of the tree corresponding to a definition of data of an elementary type. The comprehensive variable is replaced by a module that offers two primitives: reading and writing. Furthermore, this conversion implies replacement of all the explicit references to the variables by calling up either of the primitives “reading” and “writing”. A description is then given of a conversion which starts by scanning the model with a template corresponding to the comprehensive variable found in the first search.

The invention can also be used to replace dynamic code by static code. In this case, the dynamic creation of variables is replaced by static creation based on the pre-allocation of memory. The search has to be made in the tree for occurrences of instructions of the language that manage dynamic type creation.

Finally, the invention is simple to implement. In particular, it does not necessitate complex architecture.

What is claimed is:

1. A method for the conversion of computer code, comprising at least:
a first step for the acquisition of a code object model A from the original code;
a second step of conversion of the code object model A into a new object model B;
a third step of the generation of a code from the new model B.

2. A method according to claim 1, wherein step of acquisition of the code model A comprises:
a first step of creation of a syntactic tree as a function of the grammar of the original code;
a second step of conversion of the syntactic tree into a code model A.

3. A method according to claim 2, wherein the conversion of the syntactic tree into an object model A uses conversion rules to represent each node of the tree as an object.

4. A method according to claim 2, wherein the creation of the object model A is based on a meta-model forming a grammar describing the structural elements of the modeling language.

5. A method according to claim 1, wherein step of conversion of the code model A comprises:
a step of searching for patterns in the code model A;
an acquisition step to extract the elements of a zone of the model A corresponding to a pattern identical to or different from a pattern being sought;
a conversion step in which the extracted elements are modified as a function of a rule.

6. A method according to claim 5, wherein the search step applies a pattern template to retrieve a pattern in the code model A, the chosen patterns being filtered by the template.

7. A method according to claim 5 wherein, in the pattern search language, the search criteria relate to the structure of the program blocks to which a structure of the syntactic tree corresponds, the definition of the patterns being based on the description of the specific structures of the tree.

8. A method according to claim 4, wherein the meta-model associated with the new model (B) is the same as the meta-model of the model (A).

9. Computer program/product for the implementation of a method according to claim 1, comprising:
a first module for the acquisition of a code object model A from the original code;
a second module of conversion of the code model A into a new code model B, interfaced with the previous module;
a third module for the generation of a code from the new model B
